(19) United States
(12) Patent Application Publication
(10) Pub. No.: US 2009/0229276 A1
(43) Pub. Date: Sep. 17, 2009

(54) METHOD AND SYSTEM FOR THE REGASIFICATION OF LNG

(76) Inventors: Marc Alexander Rieder, The Hague (NL); David Bertil Runbalk, The Hague (NL); Alexander Emanuel Maria Straver, The Hague (NL)

Correspondence Address: SHELL OIL COMPANY, P O BOX 2463, HOUSTON, TX, 772522463, US

(21) Appl. No.: 12/293,398

(22) PCT Filed: Mar. 16, 2007
(86) PCT No.: PCT/EP2007/052496

§ 371 Date: Mar. 26, 2009

(30) Foreign Application Priority Data
Mar. 23, 2006 (EP) 06111592.9

(51) Int. Cl. F17C 9/02

(52) U.S. Cl. 62/50.2; 62/50.6; 62/50.7

(57) ABSTRACT

The present invention relates to a method for the regasification of liquefied natural gas, the method at least comprising the steps of: a) removing liquefied natural gas (10) from a storage tank (2) using a first pump unit (3); b) passing the removed liquefied natural gas (20) to and feeding it into a second pump unit (4) at an inlet pressure; c) increasing the pressure of the liquefied natural gas in the second pump unit (4) thereby obtaining pressurized liquefied natural gas (50); d) vaporizing the pressurized liquefied natural gas (50) thereby obtaining gaseous natural gas (60); wherein the second pump unit (4) discharges the pressurized liquefied natural gas (50) at a pre-selected pressure value, regardless of the inlet pressure at the second pump unit (4).

The present invention relates to a method for the regasification of liquefied natural gas (LNG).

LNG is usually primarily liquefied methane containing varying quantities of ethane, propane and butanes with trace quantities of pentanes and heavier hydrocarbon components. Usually the LNG is low in aromatic hydrocarbons and non-hydrocarbons such as H₂O, N₂, CO₂, H₂S and other sulphur compounds, and the like, as these compounds have usually been removed at least partially before liquefying the natural gas stream, which is then stored or transported in liquid form. For the purpose of this description, ‘LNG’ or ‘natural gas’ should not be construed to be limited to a certain composition, but rather be seen as a hydrocarbon containing stream.

It is desirable to liquefy natural gas for a number of reasons. As an example, natural gas can be stored and transported over long distances more readily as a liquid than in gaseous form, because it occupies a smaller volume and does not need to be stored at high pressures.

In order to regasify the LNG stream it is usually pressurized and vaporised. If desired a selected amount of e.g. N₂ is added to obtain natural gas having a desired gas quality, e.g. a selected heating value (i.e. energy content when the gas is burned), according to gas specifications or the requirements of a consumer. Alternatively or additionally, the heating value of the natural gas may be adjusted by removing or adding a desired amount of ethane and/or heavier hydrocarbons from the natural gas.

An example of a method for the regasification of LNG is disclosed in US 2006/0042312, WO 2005/045337 and WO 2005/059459.

A problem of the known method of regasifying LNG is that the processing of the LNG stream can only be done at rather narrowly defined pressures for the LNG stream for which the regasification process has been designed. If it would be desired to change the pressure of the LNG stream, this would result in significant downtime and in additional CAPEX and OPEX costs.

It is an object of the present invention to minimize the above problem.

It is a further object to provide an alternative method of regasifying LNG, which is more flexible and which can be easily adapted to different process requirements.

One or more of the above or other objects are achieved according to the present invention by providing a method for the regasification of liquefied natural gas, the method at least comprising the steps of:

a) removing liquefied natural gas from a storage tank using a first pump unit;

b) passing the removed liquefied natural gas to and feeding it into a second pump unit at an inlet pressure;

c) increasing the pressure of the liquefied natural gas in the second pump unit thereby obtaining pressurized liquefied natural gas;

d) vaporizing the pressurized liquefied natural gas thereby obtaining gaseous natural gas;

wherein the second pump unit discharges the pressurized liquefied natural gas at a pre-selected pressure value, regardless of the inlet pressure at the second pump unit.

It has surprisingly been found that using the method according to the present invention, the process flexibility can be significantly increased. An advantage of the present invention is that if the pressure of the LNG stream to be vaporized is changed, no modification or replacement of the first and second pump units is needed, which otherwise would have led to substantial downtime and CAPEX and OPEX costs.

The first pump unit may comprise any single pump or combination of pumps suitable for removing the LNG from the storage tank.

The vaporizer may be any vaporizer provided that it vaporizes the LNG. Suitable examples are so-called open rack vaporizers (ORV) and submerged combustion vaporizers (SCV), but the person skilled in the art will understand that many other vaporizers may be fit for purpose.

The second pump unit may comprise any single pump or combination of pumps that ensures that the pressurized LNG is discharged at its outlet at a pre-selected pressure value, regardless of the inlet pressure of the second pump unit. In this respect it is noted that a ‘normal pump’ (such as for example pump 59 in above-mentioned WO 2005/045337)—contrary to the second pump unit according to the present invention—discharges a stream having a pressure that is a predefined level above its inlet pressure. As a result a ‘normal pump’ will not discharge a stream with a pre-selected pressure value regardless of its inlet pressure.

According to a preferred embodiment the second pump unit comprises a variable-speed drive (VSD) motor. As a VSD motor is known as such (see e.g. Chapter 6 of Pump Handbook, 3^{rd} edition; edited by I. J. Karassik, J. P. Messina, P. Cooper, Ch. C. Heald; McGraw-Hill, 2001), it is not further discussed here. Further it is preferred that the second pump unit does not comprise a pressure control valve.

It is especially preferred that in a routing unit between the first and the second pump unit a selection is made from one of at least two flow paths between the first and second pump units. To this end the routing unit may have been designed in various ways, e.g. using a pressure drop to control the flow. It is preferred that in the first flow path the liquefied natural gas is directly passed to the second pump unit. Further it is preferred that in the second flow path the liquefied natural gas is passed to a separation column, thereby obtaining a lighter stream at a first outlet and a heavier stream at a second outlet, wherein the lighter stream obtained at the first outlet is passed to the second pump unit. The terms ‘lighter’ and ‘heavier’ are meant to indicate that the lighter stream comprises a higher concentration of higher boiling components (in particular methane) than the heavier stream.

The separation column used in the routing unit may be any separation column to extract heavier streams such as an NGL (usually ethane and heavier hydrocarbons) or LPG (usually propane and butane) extraction unit.

An important advantage of the use of the routing unit is that if desired a separation column, e.g. an NGL or LPG extraction unit, can be added to and incorporated into an existing regasification unit in an LNG import terminal without resulting in significant downtime. Furthermore, if e.g. the NGL extraction unit is shut down for maintenance purposes this can be done without shutting the whole regasification unit down. Again, this results in less downtime and costs.

According to a preferred embodiment the lighter stream obtained at the first outlet is condensed in a condenser. The person skilled in the art will understand that the condenser may take many forms as long as it can condense the lighter stream coming from the separation column. It is preferred that in the condenser the lighter stream is heat exchanged against the liquefied natural gas before it is passed to the separation column.

In a further aspect the present invention relates to a system for the regasification of liquefied natural gas, the system at least comprising:
a storage tank for the liquefied natural gas;
a first pump unit for removing the liquefied natural gas from the storage tank;
a second pump unit for increasing the pressure of the liquefied natural gas having an inlet pressure, thereby obtaining pressurized liquefied natural gas; and
a vaporizer for vaporizing the pressurized liquefied natural gas thereby obtaining a gaseous natural gas stream;

wherein the second pump unit can discharge the pressurized liquefied natural gas at a pre-selected pressure value, regardless of the inlet pressure of the liquefied natural gas at the second pump unit.

Hereinafter the invention will be further illustrated by the following non-limiting drawing. Herein shows:

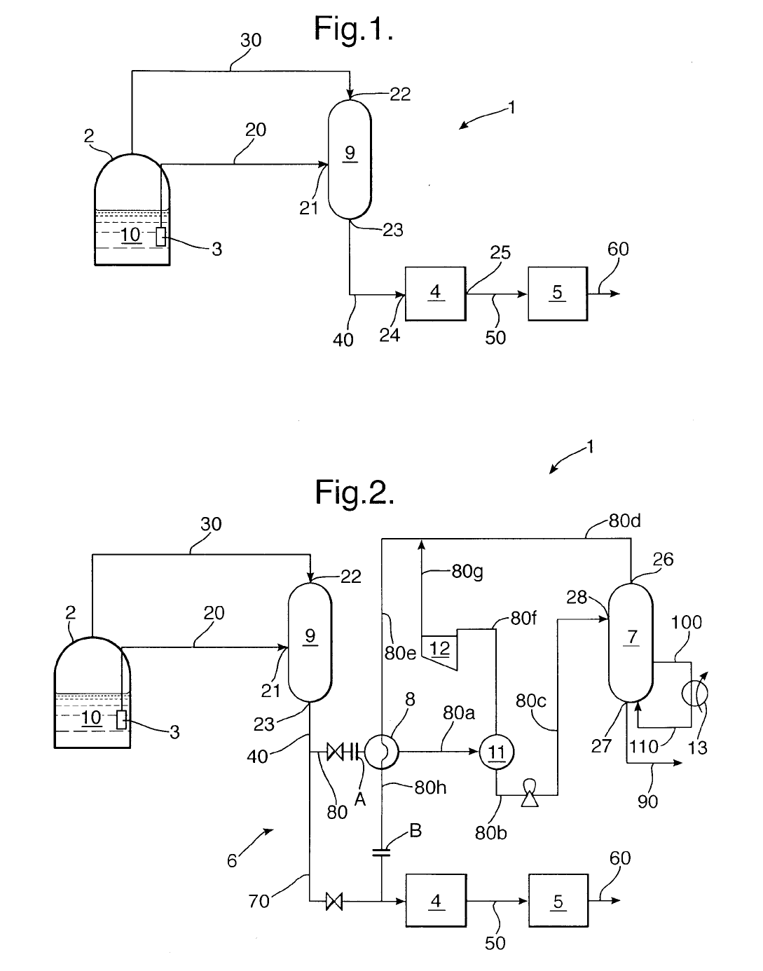

FIG. 1 schematically a process scheme in accordance with an embodiment of the present invention; and

FIG. 2 schematically a process scheme in accordance with another embodiment of the present invention.

For the purpose of this description, a single reference number will be assigned to a line as well as a stream carried in that line. Same reference numbers refer to similar components.

FIG. 1 schematically shows a process scheme (and a system generally referred to with reference No. 1) according to the present invention for the regasification of liquefied natural gas which process can be used in an LNG import terminal.

From an LNG storage tank 2 for liquefied natural gas 10 an (usually sub-cooled) LNG stream 20 is removed by use of a first pump unit 3. The first pump unit 3 may comprise two or more pumps if desired. Stream 20 generally has a pressure between 10-20 bar and is fed into an optional recondenser 9 at a first feeding point 21. To the recondenser 9 also a gaseous Boil Off Gas (BOG) stream 30 is fed at second feeding point 22, which BOG stream 30 is reliquefied by mixing with the stream 20.

From the outlet 23 of the recondenser 9 an LNG stream 40 is removed and passed to the inlet 24 of a second pump unit 4 that can discharge (at outlet 25) the resulting pressurized LNG 50 at a pre-selected pressure value (typically between about 50 and 100 bar), regardless of the inlet pressure of the LNG 40 at the inlet 24 of the second pump unit 4. To this end, the second pump unit 4 comprises a variable-speed drive motor. The pressurized LNG is passed to a vaporizer (or ‘regasifier’) 5 in which the LNG is vaporized thereby obtaining gaseous natural gas stream 60 that may be sent to the grid or gas pipe network (not shown).

An advantage of the use of the specific second pump unit 4 is that the processing of the LNG stream 40 can be processed at various pressures or flow rates, without having to change the first and second pump units 3,4.

FIG. 2 shows an exemplary process scheme of another embodiment of the method according to the present invention.

The system 1 comprises a routing unit (generally identified with 6) between the first and the second pump units 3,4. The routing unit 6 allows to select one of at least two flow paths 70 and 80 between the first and second pump units 3,4. If desired more than two flow paths may be present.

In the embodiment of FIG. 2 the first flow path 70 directly connects to the inlet 24 of the second pump unit 4. Further, the second flow path 80 includes a separation column 7 having a first outlet 26 for a lighter stream 80d and a second outlet 27 for a heavier stream 90, wherein the lighter stream 80d obtained at the first outlet 26 is passed to the inlet 24 of the second pump unit 4.

As shown in FIG. 2, the second flow path 80 comprises the steps of passing the stream 80 through a heat exchanger 8, feeding it as stream 80a into a gas/liquid separator 11, removing a bottom stream 80b and passing it as stream 80c to the feeding point 28 of the separation column 7, removing the top stream 80d from the column 7 and forwarding it (jointly with top stream 80g obtained after compressing top stream 80f from the separator 11) as stream 80e to the condenser 8.

In the condenser 8 the lighter stream 80d is heat exchanged (as stream 80e) against the LNG stream 80 before it is passed as stream 80a to the separation column 7.

The routing unit 6 may comprise further elements such as tie-points A and B, valves (not shown) and control elements to ensure that if one of the at least two flow paths 70,80 is selected the other one(s) is (are) shut off.

An important advantage of the use of the routing unit 6 in FIG. 2 is that a separation column such as the column 7 (e.g. an NGL or LPG extraction unit) can be added to and incorporated into an existing regasification unit such as indicated in FIG. 1 without resulting in significant downtime. Furthermore, if e.g. the column 7 is shut down for maintenance purposes this can be done by shutting off the second flow path 80, i.e. without the necessity of shutting the whole system 1 down. This clearly results in less downtime.

The person skilled in the art will readily understand that other streams may be present in the process scheme of FIGS. 1 and 2.

Table I gives an overview of the (estimated) composition and conditions of a stream at various parts in an example process of FIG. 2, when the first flow path is shut off.

TABLE I

| | 20 | 30 | 50 | 60 | 80 | 80d | 80e | 80h | 90 |
|---|---|---|---|---|---|---|---|---|---|
| Phase | Liquid | Vapour | L | V | L | V | V | L | L |
| | (L) | (V) | | | | | | | |
| Temperature [° C.] | −159.5 | −90 | −134.5 | 10.0 | −157.1 | −101.6 | −75.5 | −137.5 | −10.6 |
| Pressure [bar] | 13.0 | 13.0 | 76.0 | 75.0 | 13.0 | 14.0 | 20.0 | 20.0 | 14.1 |
| Molar fraction | | | | | | | | | |
| N₂ | 0.010 | 0.057 | 0.011 | 0.011 | 0.011 | 0.002 | 0.011 | 0.011 | — |
| Methane | 0.907 | 0.939 | 0.974 | 0.974 | 0.908 | 0.981 | 0.974 | 0.974 | 0.013 |
| Ethane | 0.060 | 0.004 | 0.015 | 0.015 | 0.059 | 0.017 | 0.015 | 0.015 | 0.662 |
| Propane | 0.020 | — | — | — | 0.020 | 0.001 | — | — | 0.281 |
| i-Butane | 0.001 | — | — | — | 0.001 | — | — | — | 0.016 |
| Butane | 0.001 | — | — | — | 0.001 | — | — | — | 0.015 |

1. A method for the regasification of liquefied natural gas, the method at least comprising the steps of:
a) removing liquefied natural gas from a storage tank (using a first pump unit;
b) passing the removed liquefied natural gas to and feeding it into a second pump unit at an inlet pressure;
c) increasing the pressure of the liquefied natural gas in the second pump unit thereby obtaining pressurized liquefied natural gas; and
d) vaporizing the pressurized liquefied natural gas thereby obtaining gaseous natural gas;
wherein the second pump unit discharges the pressurized liquefied natural gas at a pre-selected pressure value, regardless of the inlet pressure at the second pump unit.

2. The method according to claim 1, wherein the second pump unit comprises a variable-speed drive motor.

3. The method according to claim 1, wherein the second pump unit does not comprise a pressure control valve.

4. The method according to claim 1, wherein between the first and the second pump unit a selection is made from one of at least two flow paths between the first and second pump units.

5. The method according to claim 4, wherein in the first flow path the liquefied natural gas is directly passed to the second pump unit.

6. The method according to claim 4, wherein in the second flow path the liquefied natural gas is passed to a separation column, thereby obtaining a lighter stream at a first outlet (and a heavier stream at a second outlet, wherein the lighter stream obtained at the first outlet is passed to the second pump unit.

7. The method according to claim 6, wherein the lighter stream obtained at the first outlet (is condensed in a condenser.

8. The method according to claim 7, wherein in the condenser the lighter stream is heat exchanged against the liquefied natural gas before it is passed to the separation column.

9. A system for the regasification of liquefied natural gas, the system at least comprising:
a storage tank (for the liquefied natural gas;
a first pump unit for removing the liquefied natural gas from the storage tank
a second pump unit for increasing the pressure of the liquefied natural gas having an inlet pressure, thereby obtaining pressurized liquefied natural gas; and
a vaporizer for vaporizing the pressurized liquefied natural gas thereby obtaining a gaseous natural gas stream;
wherein the second pump unit can discharge the pressurized liquefied natural gas at a pre-selected pressure value, regardless of the inlet pressure of the liquefied natural gas at the second pump unit.

10. The system according to claim 9, wherein the second pump unit comprises a variable-speed drive motor.

11. The system according to claim 9, wherein the second pump unit does not comprise a pressure control valve.

12. The system according to claim 9, further comprising a routing unit between the first and the second pump units, wherein the routing unit can allow a selection of one of at least two flow paths between the first and second pump units.

13. The system according to claim 12, wherein the first flow path directly connects to the second pump unit.

14. The system according to claim 12, wherein the second flow path includes a separation column having a first outlet for a lighter stream and a second outlet for a heavier stream, wherein the lighter stream obtained at the first outlet can be passed to the second pump unit.

15. The system according to claim 14, wherein the second flow path further includes a condenser for condensing the lighter stream.

16. The system according to claim 15, wherein in the condenser the lighter stream can be heat exchanged against the liquefied natural gas before it is passed to the separation column.

17. The system according to claim 9, further comprising a recondenser between the first pump unit and the routing unit in which a boil off gas stream can be recondensed.

18. The method according to claim 2, wherein the second pump unit does not comprise a pressure control valve.

19. The method according to claim 2, wherein between the first and the second pump unit a selection is made from one of at least two flow paths between the first and second pump units.

20. The method according to claim 3, wherein between the first and the second pump unit a selection is made from one of at least two flow paths between the first and second pump units.
